(19) United States
(12) Patent Application Publication
(10) Pub. No.: US 2025/0355919 A1
(43) Pub. Date: Nov. 20, 2025

(54) SYSTEM AND METHOD FOR PROVIDING CONTEXT OF WEB CONTENT

(71) Applicant: YAHOO ASSETS LLC, New York, NY (US)

(72) Inventors: Ran Moshe, Zichron (IL); Yaroslav Fyodorov, Haifa (IL); Fiana Raiber, Karmiel (IL)

(21) Appl. No.: 18/664,738

(22) Filed: May 15, 2024

(51) Int. Cl. G06F 16/34; G06F 3/04842; G06F 40/30

(52) U.S. Cl. CPC G06F 16/345; G06F 3/04842; G06F 40/30

(57) ABSTRACT

The present teaching relates to providing contextual information to web content. Relevant information is extracted from a current article that a user is reviewing. Contextual information associated with the current article is retrieved from a database based on the extracted relevant information. A zoom-out summary of the contextual information is automatically generated to characterize the background of the current article. A zoom-out option is presented to the user that allows the user to review, once the option is activated, the zoom-out summary to understand the background of the current article.

### BACKGROUND

### 1. Technical Field

The present teaching generally relates to information processing. More specifically, the present teaching relates to providing contextual information for online content.

### 2. Technical Background

With the development of the Internet and the ubiquitous network connections, daily activities are often conducted online, including reading content in different subject matters. Digital content is delivered to millions of users, either requested or recommended, via network connections to keep people informed of what is going on in the world. Such online content includes media reports, articles, communications, as well as discussions directed to different topics. FIG. 1A illustrates a typical graphical user interface (GUI) 100 (either on a handheld device or on a computer) for a user to access online content. In this example, GUI 100 may include different regions, including a search area 110, some tool buttons 120-140 for, e.g., activating different search modes, a content display area 150, some auxiliary areas, e.g., 160 and 170, for associated content or advertisement, and sliding bars 180 and 190 for sliding content on display in a horizontal or a vertical direction.

The display area 150 may be used to display the searched content, e.g., an article with content consistent with keywords a user provides in the search window 110. FIG. 1B shows an exemplary article displayed in display area 150 from Los Angeles Times reporting on Japan's intent to cut the carbon and the challengers Japan is facing because of the Fukushima nuclear disaster. A reader may read the full article by scrolling down via 190. Although the article may mention that challenges are due to the Fukushima nuclear disaster, the historical information related to the event may not be provided in the article. However, to better understand viewpoints conveyed in the article, one may need to know additional contextual information. Traditionally, a reader needs to perform additional searches to identify such information. The keywords for such additional searches may be appropriately determined in order to get the information on point, which requires effort and can be time consuming.

Thus, there is a need for developing an approach to overcome the shortcomings associated with the current state of the art.

### SUMMARY

The teachings disclosed herein relate to methods, systems, and programming for information management. More particularly, the present teaching relates to methods, systems, and programming related to content summarization.

In one example, a method, implemented on a machine having at least one processor, storage, and a communication platform capable of connecting to a network for providing contextual information to web content. Relevant information is extracted from a current article that a user is reviewing. Contextual information associated with the current article is retrieved from a database based on the extracted relevant information. A zoom-out summary of the contextual information is automatically generated to characterize the background of the current article. A zoom-out option is presented to the user that allows the user to review, once the option is activated, the zoom-out summary to understand the background of the current article.

In a different example, a system is disclosed for providing contextual information to web content. The system includes a story information extractor, a relevant past content retriever, a zoom-out summary generator, and a zoom-out information renderer. The story information extractor extracts relevant information from a current article that a user is reviewing. The relevant past content retriever is provided for retrieving contextual information associated with the current article from a database based on the extracted relevant information. The zoom-out summary generator automatically generates a zoom-out summary of the contextual information to characterize the background of the current article. The zoom-out information renderer presents a zoom-out option to the user that allows the user to review, once the option is activated, the zoom-out summary to understand the background of the current article.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for providing contextual information to web content. Relevant information is extracted from a current article that a user is reviewing. Contextual information associated with the current article is retrieved from a database based on the extracted relevant information. A zoom-out summary of the contextual information is automatically generated to characterize the background of the current article. A zoom-out option is presented to the user that allows the user to review, once the option is activated, the zoom-out summary to understand the background of the current article.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary GUI for accessing online information;

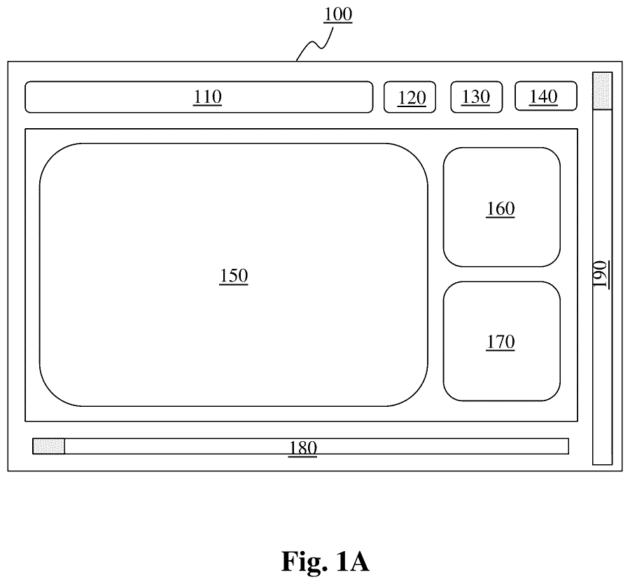

FIG. 1B illustrates an article displayed in a sub-window on a GUI;

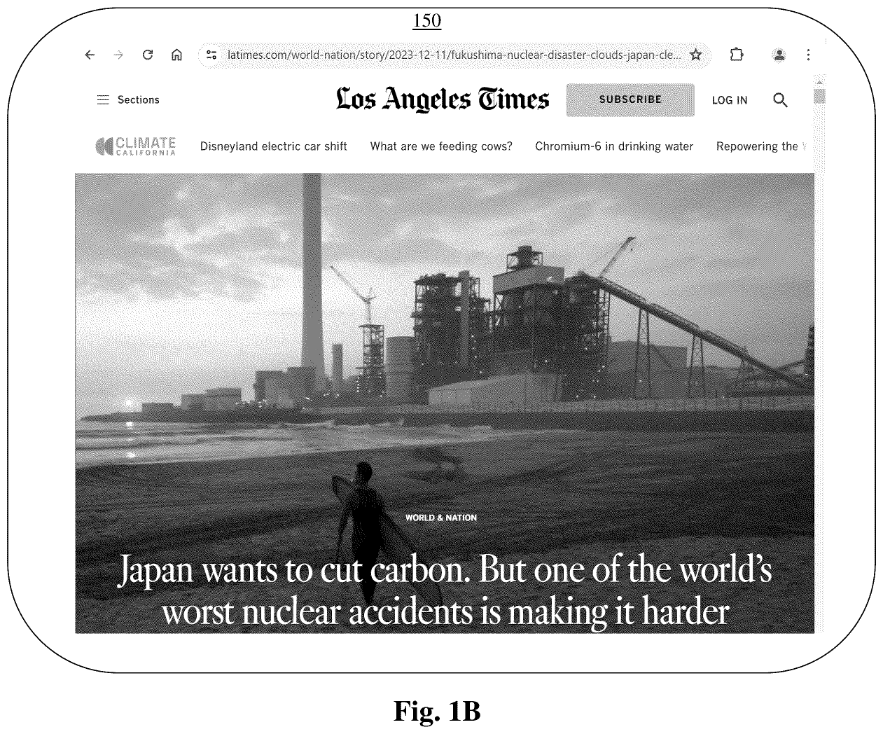

FIG. 2A shows an exemplary online article displayed with a zoom-out option for accessing a summary of the contextual information related to the article, in accordance with an embodiment of the present teaching;

FIG. 2B illustrates an exemplary rendering of a zoom-out summary on context related to a displayed article, in accordance with an embodiment of the present teaching;

FIG. 3A depicts an exemplary high level system diagram of a framework for offering an option for accessing a zoom-out summary of an online article displayed to a user, in accordance with an embodiment of the present teaching;

FIG. 3B is a flowchart of an exemplary process of a framework for offering an option for accessing a zoom-out summary of an online article displayed to a user, in accordance with an embodiment of the present teaching;

FIG. 4A shows exemplary types of information archived in a content database to facilitate automatic generation of zoom-out summaries, in accordance with an embodiment of the present teaching;

FIG. 4B illustrates exemplary types of information associated with an article that may be used to automatically create a zoom-out summary, in accordance with an embodiment of the present teaching;

FIG. 4C illustrates exemplary types of information that may be incorporated in a zoom-out summary, in accordance with an embodiment of the present teaching;

FIG. 4D shows exemplary types of parameters that may be used in generating a zoom-out summary, in accordance with an embodiment of the present teaching;

FIG. 5A depicts an exemplary high level system diagram of a zoom-out summary generator, in accordance with an embodiment of the present teaching;

FIG. 5B is a flowchart of an exemplary process of a zoom-out summary generator, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses a framework for automatically generating a zoom-out summary of contextual information associated with an online article displayed to a user and providing an option to the user for easy access of the zoom-out summary while reviewing the online article. The article is processed to extract different information such as source of the article, entities mentioned in the article, topics covered by the article, etc. Based on the extracted information from the article, contextual information related thereto may be retrieved from a database that includes not only historic documents/articles but also statistics thereof and/or one or more knowledge graphs constructed based on the archived documents/articles.

A knowledge graph may be constructed to capture some relationships. For example, a knowledge graph may be used to represent relationships among entities according to content included in the historic documents/articles. For example, Chernobyl and Ukraine may be entities that are connected because one is a city in the other. Similarly, Fukushima and Japan may be entities connected with the same relation (e.g., belong to). Chernobyl power plant may be another entity identified from historic documents that may be connected to both entity Chernobyl and entity Ukraine because it is geographically related to both. Similarly, entity Fukushima nuclear power plant may be connected in a knowledge graph to both entity Fukushima and entity Japan entity as it is geographically associated with both. Based on historic documents/articles, entities for Chernobyl power plant and Fukushima nuclear power plant may be connected to each other as they both had nuclear power plant accidents in the past according to the historic documents. Each may also be connected to another entity, which may be related to nuclear power plant disaster, each connection may be provided with attributes describing the connection. For instance, the attributes associated with the link between Fukushima nuclear power plant and nuclear power plant disaster may include, e.g., a date of the accident, the death toll of the disaster, etc. so that when the link is identified, certain features established based on historic documents may also be obtained. Each node in a knowledge graph representing an entity may also be associated with a set of attributes, including, e.g., pointers to documents/articles with content associated with the entity. Based on knowledge graphs, different entities associated with, e.g., that extracted from an online article may be identified and then used to identify other associated entities and/or historic documents/articles connected to the relevant entities.

A knowledge graph may also capture relationships among different topics. For instance, a topic on Fukushima (e.g., a node in a knowledge graph) is related to the topic on the well-known Fukushima nuclear disaster (another node in the knowledge graph). In addition, both nodes on topics of Fukushima and Chernobyl nuclear disasters may both connected to a node on topic, e.g., nuclear accidents. Through links among nodes representing relations among different topics, a knowledge graph may be used to trace, based on a topic identified in an online article that a user is reviewing, other historic documents/articles stored in the database on the same or related topics. Documents/articles stored in the database can be identified dynamically via knowledge graphs based on relationships between entities/topics extracted from an online article and that presented in those historic documents/articles, which may be used to automatically generate a zoom-out summary of the historic contextual information associated with the online article so that the user is provided with an option to the user to review the summary of the context of the discussion presented in the online article.

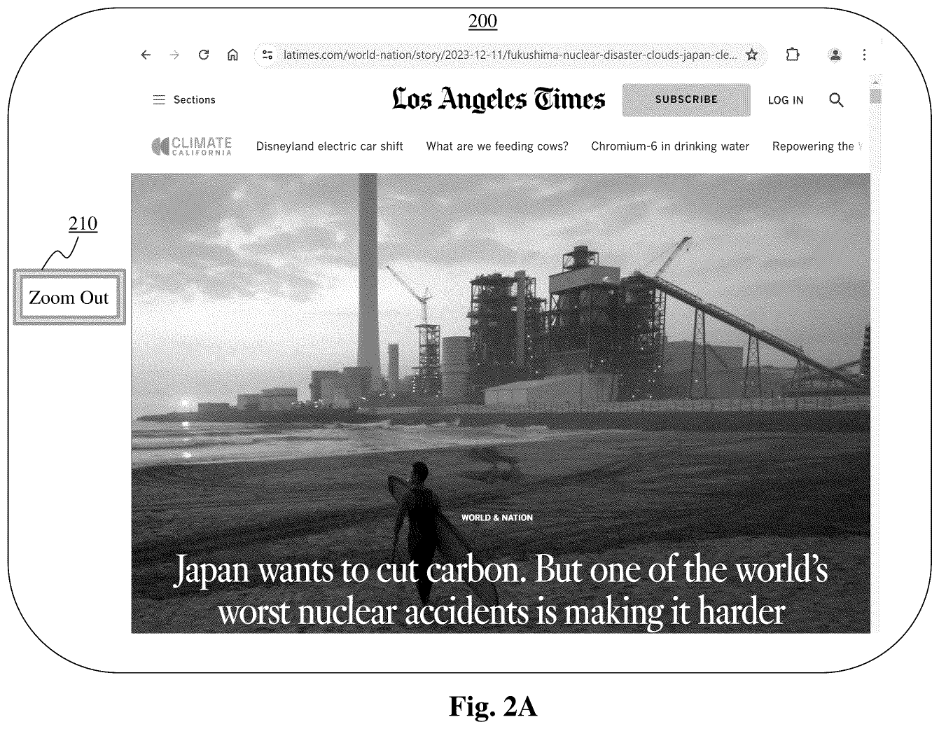

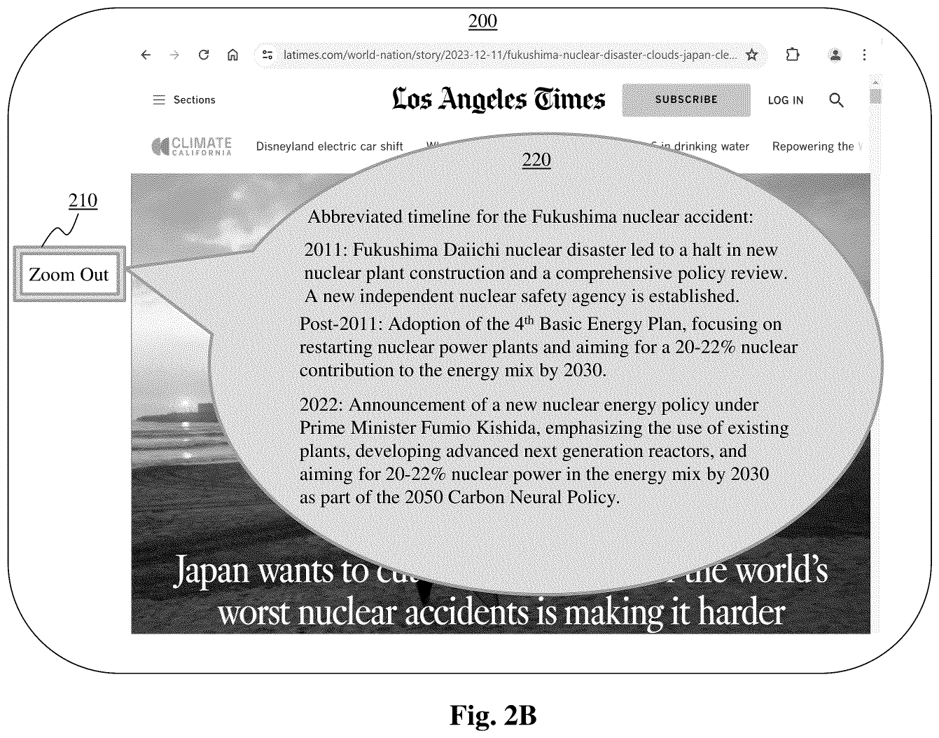

FIG. 2A shows an online article is displayed with an option of accessing a zoom-out summary of the contextual information related to the article, in accordance with an embodiment of the present teaching. In this illustration, the online article discussing Japan's policy consideration to reduce carbon is displayed in an example sub-window 200 with an actionable icon 210 presenting an option to the user to review a zoom-out summary of contextual information related to the article displayed. FIG. 2B illustrates an exemplary rendering of the zoom-out summary of context of a displayed article when the actionable option 210 is activated, in accordance with an embodiment of the present teaching. As shown, this exemplary zoom-out summary includes content automatically generated based on historic documents/articles related to the disaster at the Fukushima nuclear power plant and some historic effort up to that point to control the nuclear contribution to the power industry. In this example, the zoom-out summary 220 is displayed by superimposing the content of the zoom-out summary over the displayed article. Other means to render the zoom-out summary may also be implemented. In some embodiments, the sub-window 200 may be split into two disjoint portions (not shown) with one displaying the article and the other the zoom-out summary of the article. Other rendering schemes may also be possible. With the zoom-out summary, a user who is viewing an online article may get a snapshot of the background information that is keyed on the point(s) of discussion presented in the online article. With this option, a user can review, when needed, the contextual information with one a single click without requiring the effort of figuring out the new keywords and then performing separate additional searches using these new keywords.

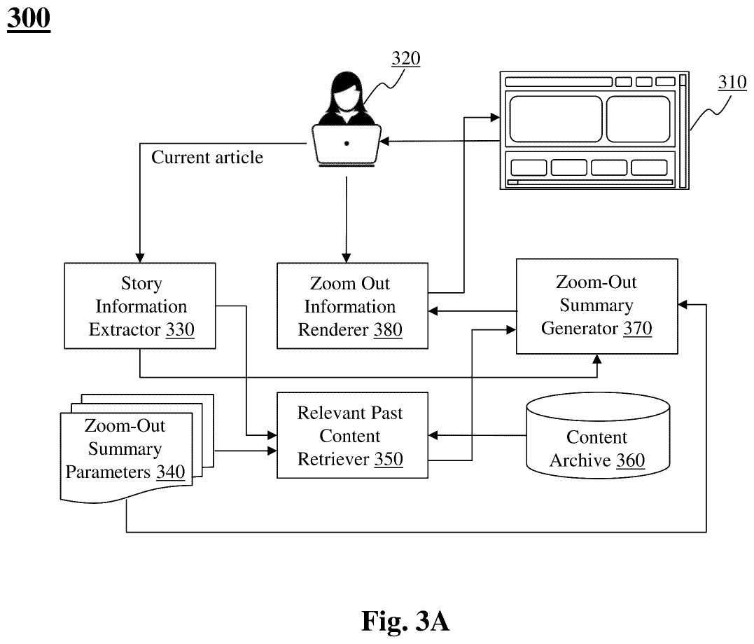

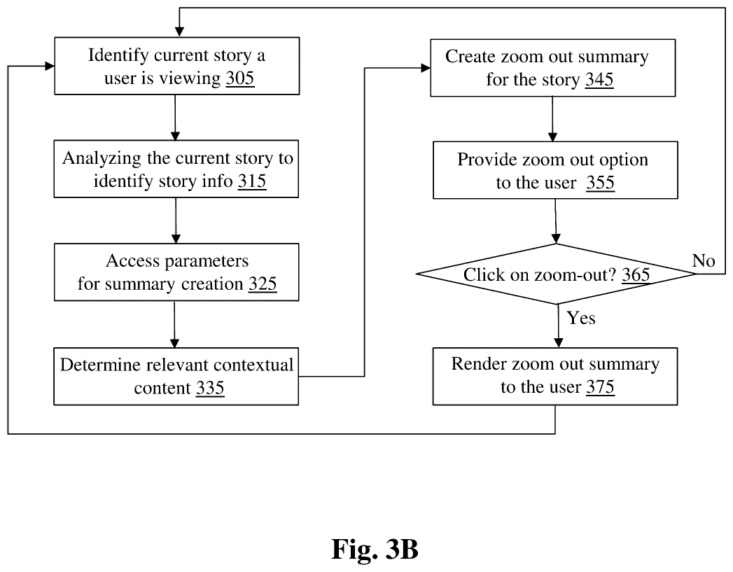

FIG. 3A depicts an exemplary high level system diagram of a framework 300 for offering a zoom-out option for accessing a zoom-out summary of an online article displayed to a user, in accordance with an embodiment of the present teaching. In this illustrated embodiment, the framework 300 comprises a GUI 310, a story information extractor 330, a relevant past content retriever 350, a zoom-out summary generator 370, and a zoom-out information renderer 380. A user interest with the GUI 310 to search online articles and a current online article from the search is displayed on the GUI 310. To automatically generate a zoom-out summary of the context of the current article, the current article is provided to the story information extractor 330, which extracts different types of information (e.g., source of the current article, entities, and topics) that may be used in controlling the generation of the zoom-out summary. For instance, the source of the current article may be determined. This information may be used to control the linguistic style to be used in generating the zoom-out summary so that it is consistent with that of the current article. For example, an article from Los Angeles Times may have a different style from that of New York Times so that a zoom-out summary to be generated for the illustrated article from Los Angeles Times as shown in FIG. 2B may be created to use the style known for Los Angeles Times.

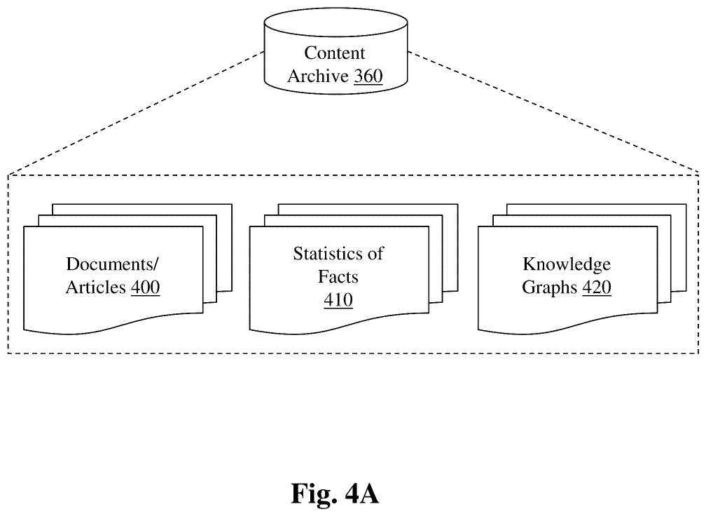

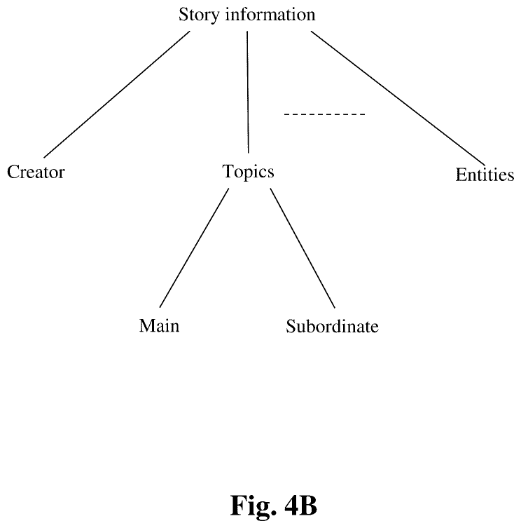

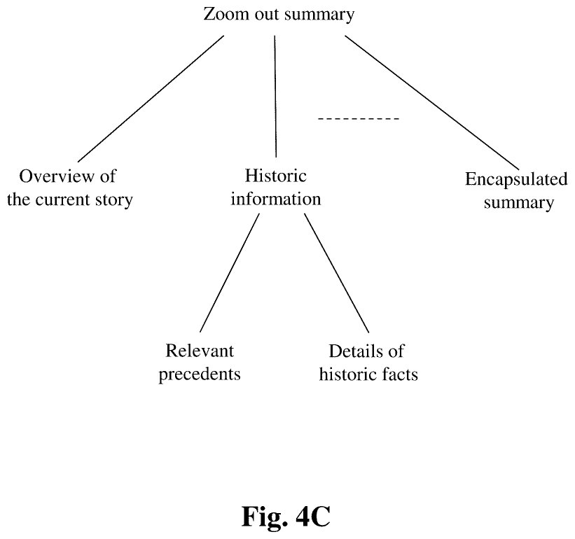

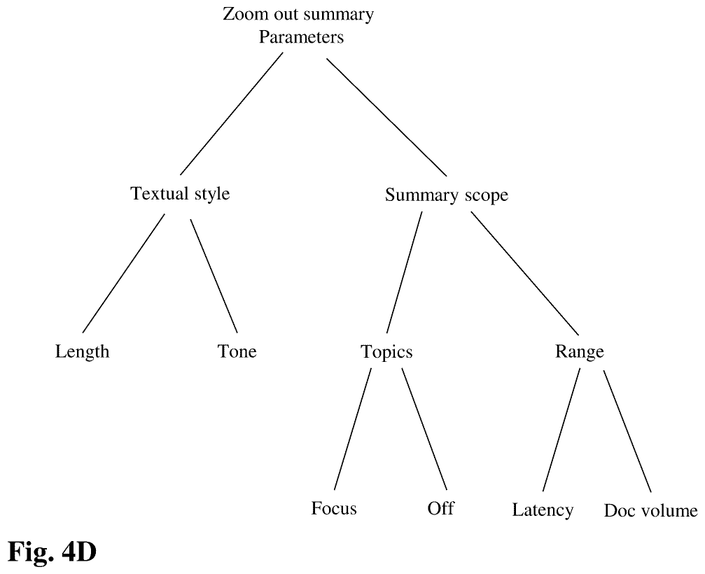

The relevant past content retriever 350 may be provided to retrieve, from a content archive 360, historic documents/articles or other information that are relevant to the current article (determined based on the story information extracted from the current article). FIG. 4A shows exemplary types of information archived in the content archive 360 for facilitating automatic generation of zoom-out summaries, in accordance with an embodiment of the present teaching. As illustrated, the archived content may include historic documents/articles 400, various statistics of facts 410 directed to different aspects that may be computed based on content archived (e.g., the death toll in Fukushima nuclear disaster), and one or more knowledge graphs 420 that characterize different types of relations existing among different entities/topics/events according to the content of the archived historic documents/articles. FIG. 4B illustrates exemplary types of information that may be extracted from a current article to facilitate automatic creation of a zoom-out summary, in accordance with an embodiment of the present teaching. As discussed herein, characterizing information associated with a current story may include the creator of the current article (e.g., Los Angeles Times), entities mentioned in the current article, . . . , and/or topics covered by the current article. In general, an article usually covers multiple topics, including main topics (e.g., carbon reduction, Japanese policy) and subordinate topics (e.g., Fukushima).

The topics extracted from the current article may be used to determine the substantive scope of the contextual information to be retrieved for creating the zoom-out summary. In addition to the scope on the historic content used for creating a zoom-out summary, in some embodiments, the scope of content in a zoom-out summary may also be specified. FIG. 4C illustrates exemplary types of information that may be incorporated in a zoom-out summary, in accordance with an embodiment of the present teaching. As shown, a zoom-out summary may include an overview of the current article, a summary of the historic information, . . . , and an encapsulated summary such as a timeline of relevant information. In some embodiments, historic information may be summarized in terms of both relevant precedent events related to the current story as well as some details on historic facts.

The specification of what is to be included in a zoom-out summary may be used to determine what needs to be retrieved from the content archive 360 for the zoom-out summary. In some embodiments, this may be further determined based on configured parameters stored in a zoom-out summary parameter storage 340. FIG. 4D shows exemplary types of parameters that may be used in controlling how to create a zoom-out summary, in accordance with an embodiment of the present teaching. As illustrated, such zoom-out summary parameters may include formality related specification on textual style of the zoom-out summary, such as a length requirement or the tone to be applied (e.g., using a tone consistent with the creator of the current article).

In addition to the formality related parameters, there are other parameters configured to control the scope of the substantive content of the summary. For instance, parameters may be specified to limit, e.g., topics to be covered so that focusing only a certain number of the most important topics. In some situations, the specification may also be made to provide, e.g., topics that are off limit. As there is a limited real estate on GUI 310 for rendering a zoom-out summary, other parameters may also be specified to limit, e.g., the length of the summary and/or how far back to retrieve the historic documents/articles to restrict the amount of contextual information to be included in the zoom-out summary. Thus, the relevant past content retriever 350 may also rely on the zoom-out summary parameters from 340 to determine historic documents/articles/statistics to retrieve.

The contextual information retrieved from content archive 360 is then provided to the zoom-out summary generator 370, which then automatically generates a zoom-out summer of the contextual information. As shown in FIG. 3A, such generated zoom-out summary of the context/background of the current article is then sent to the zoom-out information renderer 380 so that an actionable icon 210 (see FIG. 2A) may be rendered on GUI 200 to provide an option to the user 310. When the user elects to activate the icon 210, the activation signal is provided to the zoom-out information renderer 380 so that the automatically generated zoom-out summary of the context related to the current article is then displayed on GUI 310 as the zoom-out summary 220 as shown in FIG. 2B.

FIG. 3B is a flowchart of an exemplary process of a framework for offering an option for accessing a zoom-out summary of an online article displayed to a user, in accordance with an embodiment of the present teaching. When a user is interacting with the GUI 310, the current article displayed on GUI 310 is identified at 305 and provided to the story information extractor 330, which analyzes the current article to extract relevant information at 315 and send the extracted information to the relevant past content retriever 350. To determine the scope of historic documents/articles/statistics to retrieve, the relevant past content retriever 350 accesses, at 325, parameters specified in 340 for controlling the summary creation. As discussed herein, contextual information related to the current article may be determined based on the knowledge graphs by tracing links therein to identify entities/events/topics etc. that are connected with the identities/topics extracted from the current article.

Based on the relevant information extracted from the current article (e.g., source, entities, and topics) and the parameters relating to the scope of the zoom-out summary, contextual information related to the current article is determined and retrieved, at 335, from the content archive 360. Such retrieved contextual information is then used by the zoom-out summary generator 370 to create, at 345, a zoom-out summary of the current article. Upon creating the zoom-out summary for the current article, the zoom-out information renderer 380 provides the option to the user at 355. If the user elects to view the zoom-out summary, determined at 365, the zoom-out summary of the context of the current article is then rendered, at 375, to the user.

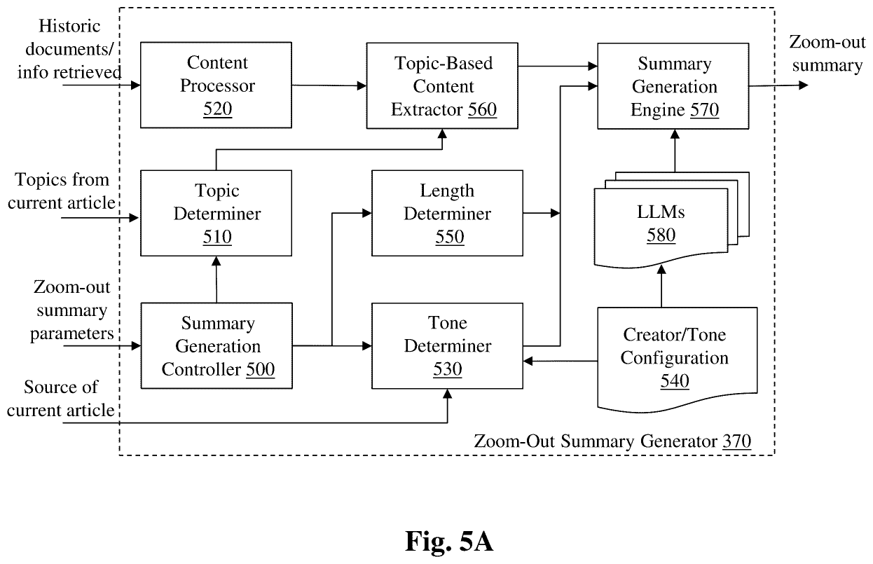

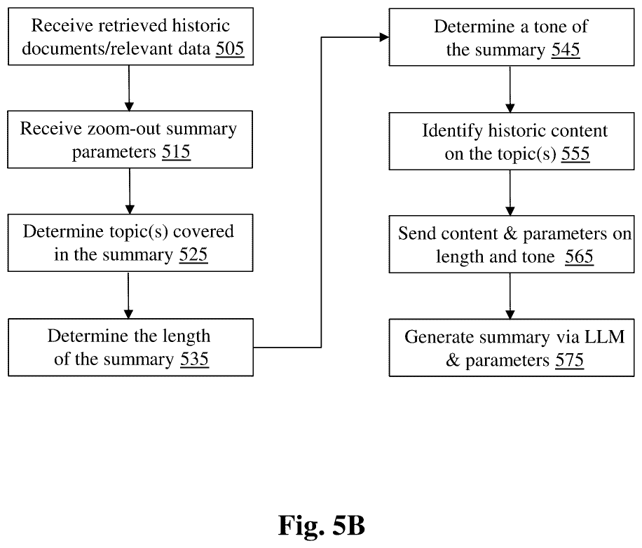

FIG. 5A depicts an exemplary high level system diagram of the zoom-out summary generator 370, in accordance with an embodiment of the present teaching. As discussed herein, the zoom-out summary generator 370 is provided to create a zoom-out summary of the contextual information related to a current article. The creation is based on the contextual information and certain zoom-out summary parameters 340 specified to control the content and style of the zoom-out summary. The contextual information is provided by the relevant past content retriever 350 based on relevant information extracted from the current article. As discussed herein, the contextual information so obtained may also be determined based on certain parameters specified in 340 regarding, e.g., what is to be included in the zoom-out summary. The creation process may also be controlled by zoom-out summary parameters 340, e.g., the number of key topics included, the latency of the historic documents/article, the length of the summary, and/or the tone of the summary, etc.

The zoom-out summary generator 370 in the illustrated embodiment as shown in FIG. 5A comprises a summary generation controller 500, a topic determiner 510, a content processor 520, a tone determiner 530, a length determiner 550, a topic-based content extractor 560, and a summary generation engine 570. The summary generation controller 500 is provided for controlling the summary creation process based on input zoom-out summary parameters 340. In some embodiments, the input zoom-out summary parameters may specify, e.g., the topics to be focusing on for the zoom-out summary, the length of the summary, and a tone to be used in generating the summary. Based on the input parameters, the summary generation controller 500 forwards relevant control parameters to appropriate determiners to be compliant. For example, parameters related to topic restrictions may be forwarded to the topic determiner 510; parameters limiting the tone of the summary are forwarded to the tone determiner 530; parameters limiting the length of the summary are forwarded to the length determiner 550.

In some embodiments, the parameters related to topic restrictions may be specified as the top 2 topics. With such limitations, the topic determiner 510 may access the topics extracted by the story information extractor 330 from the current article and determine the topic(s) to focus on for the zoom-out summary. In some embodiments, the detected topics may each be associated with a metric, e.g., a ranking of relevance to the current article. Then the top topics according to the restriction parameters may then be selected based on the metrics associated with the topics. Such determined topics may then be provided to the topic-based content extractor 560 so that content from the historic documents/articles on the determined topics may be extracted and used in creating the zoom-out summary.

In some embodiments, the length related parameters may specify some conditions to limit the length of the zoom-out summary. For example, such a limit may be the number of words included in the summary. In other examples, the length limit may be specified in an adaptive manner. For instance, the length limit may be provided as to the real estate area on the GUI 310 when the zoom-out summary is displayed. The limit may be that the sub-window 220 (see FIG. 2B) for displaying the zoom-out summary cannot be beyond the sub-window 200 (that displays the current article so that other types of content such as advertisement presented on GUI 310 is not obscured) and the font size cannot be smaller than a certain size. In this case, the size of the sub-window 220 and the font size are variables so that the amount of text to be included in the summary can vary while still compliant with the restrictions. Limitations specified in this manner makes it possible to adapt to different application settings while, e.g., operating on different devices with display screens of different sizes/shapes (e.g., a computer, a tablet, a handheld device, or even a wearable device), different GUI configurations (e.g., proportions among different sub-windows on a GUI), etc. Provided with such specified parameters from the summary generation controller 500, the length determiner 550 may then determine the amount of text to be included in the zoom-out summary (e.g., the number of words) based on, e.g., the configuration of GUI 310 (e.g., size, shape, and proportions of different sub-windows therein) and a font size to be used to display the summary. Such determined limit on the amount of text (i.e., the number of words) may then be provided to the summary generation engine 570.

As discussed herein, in some embodiments, the zoom-out summary may be created in a textual style that is consistent with that of the current article. It may often be the case that articles from different sources/authors may have quite different writing styles or tones. For instance, the writing style of articles published by the New York Times may be distinctly different from that of articles from the Washington Post. There may be parameters specifying the tone of the summary to be created. For instance, in some configuration, it may indicate to adopt the tone consistent with that of the current article. In some configuration, such parameters may be configured to instruct to use a free style, i.e., no need to adapt the style/tone to each known source of a current article. When the specification is to develop a summer in the former situation, i.e., using the same tone as that of the current article, the tone determiner 530 may receive input from the story information extractor 330 about the source of the current article (see FIG. 3A) identified from the current article, and retrieve the tone corresponding to the creator of the current article. The tone associated with the creator of the current article may be identified from the creator/tone configuration 540 that provides, e.g., correspondences between creators of articles and tones adopted by such creators. In some embodiments, such correspondences may be previously learned from past documents/articles from different creators/sources. Individual tones associated with different creators may also be learned and characterized using learned models, which may be used by the large language models (LLMs) 580 when creating a summary of input content using a certain tone characterized by models learned previously.

With the historic documents/articles (extracted by the topic-based content extractor 560) on topics to be covered in the zoom-out summary (determined by the topic determiner 510), the length of the zoom-out summary (determined by the length determiner 550), as well as an indication of the tone of the zoom-out summary (from the tone determiner 530), the summary generation engine 570 proceeds to generate, via the LLMs, the zoom-out summary of the contextual information of the current article. In creating the summary in a tone specified, some of the LLMs 580 may be particularly trained with respect to various types of tones associated with different sources of information.

FIG. 5B is a flowchart of an exemplary process of the zoom-out summary generator 370, in accordance with an embodiment of the present teaching. In operation, the content processor 520 receives, at 505, historic documents/articles retrieved by the relevant past content retriever 350 based on information extracted from the current article. The summary generation controller 500 receives, at 515, some zoom-out summary parameters to be used to control the creation of the summary and forwards different parameters to appropriate determiners. The topic determiner 510, upon receiving the parameters specifying limitations on topics, determines, at 525, the topic(s) to be considered by the summary. The length determiner 550 analyzes the received parametric instructions (e.g., display region not exceeding the region for displaying the current article, minimum font size, etc.) as well as the other information (e.g., the device platform, shape, etc.) to determine, at 535, the length of the summary in terms of, e.g., the number of words included therein. Similarly, the tone determiner 530 determines, at 545, the tone to be applied to the zoom-out summary based on the input parameters specifying, e.g., whether to adapt the tone to the creator of the current article.

Based on the topic(s) to be covered by the zoom-out summary, the topic-based content extractor 560 identify, at 555, historic documents/articles on the topic(s). The content on the topic(s) as well as various parameters related to length and style are then sent to the summary generation engine 570 at 565, which then generates the zoom-out summary of the contextual information (the historic documents/articles on the determined topic(s)) in compliant with the parameters specified in terms of, e.g., length, tone, etc., in accordance with the LLMs 580 previously trained to create a summary of a limited length given input textual information. As discussed herein, in some embodiments, the LLMs 580 may also include individual models with respect to different tones so that when a specific tone is to be used for a zoom-out summary, a corresponding LLM models trained for that specific tone may be invoked to generate a summary with that tone.

In some embodiments, different zoom-out summaries created for the same online article (e.g., corresponding to different length, on different topics, or using different ones) may be archived for quick access in a specified time window. For instance, if the same article on Japan's policy on nuclear energy mix in light of the Fukushima nuclear power plant disaster is accessed by different users within a given short period of time, e.g., on the same day, then a zoom-out summary of the background information related to this story may be repeatedly applied to different users. The reason of restricting to a short period of time may be due to the consideration that the background information available on the Internet may change over time.

As discussed herein, the zoom-out summary of the contextual information associated with a current article generated according to the present teaching may then be rendered to the user according to the configuration to provide the user 320 a condensed version of the background information associated with the current story when user 320 elects to review the summary by clicking on the zoom-out icon 220. In this manner, the present teaching enables a user to readily access relevant background information related to an article that the user is reading without having to determine how to search for such background information and proceed to perform multiple rounds of searches. This prevents repetitive searches required of the users, leading to enhanced user experience and efficiency in using the online content.

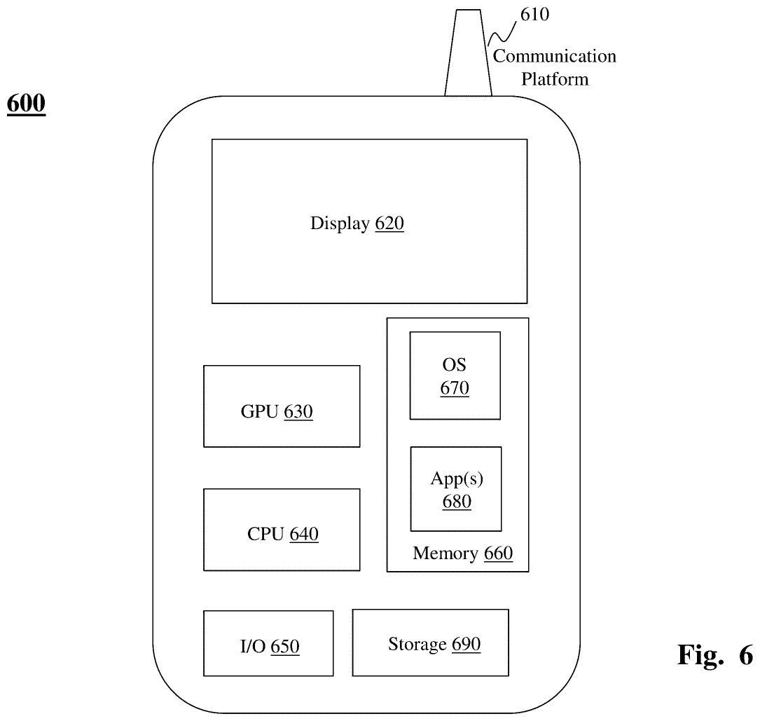

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 500, including, but not limited to, a smart phone, a tablet, a music player, a handled gaming console, a global positioning system (GPS) receiver, and a wearable computing device, or in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 500. As shown in FIG. 6, a mobile operating system 670 (e.g., iOS, Android, Windows Phone, etc.), and one or more applications 680 may be loaded into memory 660 from storage 690 in order to be executed by the CPU 640. The applications 680 may include a user interface or any other suitable mobile apps for information analytics and management according to the present teaching on, at least partially, the mobile device 600. User interactions, if any, may be achieved via the I/O devices 650 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

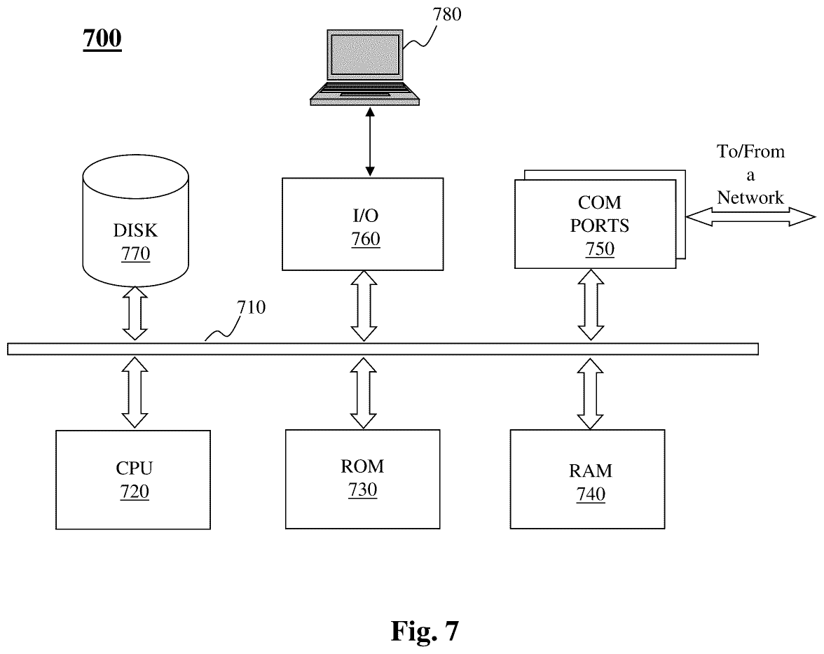

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information analytical and management method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, comprising:
receiving a current article that a user is reviewing on a graphical user interface (GUI);
extracting, from the current article, relevant information;
retrieving contextual information associated with the current article based on the extracted relevant information;
automatically generating a zoom-out summary of the contextual information to characterize background of the current article; and
providing a zoom-out option to the user on the GUI that allows, once activated, the user to review the zoom-out summary of the contextual information providing the background associated with the current article.

2. The method of claim 1, wherein the relevant information includes:
a source of the current article;
one or more entities mentioned in the current article; and
one or more topics that the current article covers.

3. The method of claim 2, wherein the step of retrieving contextual information associated with the current article comprises:
identifying one or more historic documents/articles related to the one or more entities and/or the one or more topics via a knowledge representation characterizing relationships among a plurality of historic documents/articles;
retrieving, from a content archive, at least one of some of the one or more historic documents/articles and statistics associated with the one or more historic documents/articles; and
generating the contextual information based on what is retrieved from the content archive.

4. The method of claim 3, wherein the one or more historic documents/articles and the statistics associated therewith are retrieved with respect to a first set of zoom-out summary parameter.

5. The method of claim 1, wherein the step of automatically generating a zoom-out summary comprises:
receiving a second set of zoom-out summary parameters for controlling the generation of the zoom-out summary;
receiving the contextual information identified based on the relevant information extracted from the current article; and
creating, based on large language models (LLMs), the zoom-out summary of the contextual information in compliant with the second set of zoom-out summary parameters.

6. The method of claim 5, wherein the second set of zoom-out summary parameters include at least one of:
a first parameter relating to topics to be covered by the zoom-out summary;
a second parameter relating to a limit to length of the zoom-out summary; and
a third parameter relating to a tone of text in the zoom-out summary.

7. The method of claim 1, further comprising:
receiving an indication from the GUI that the user activates the zoom-out option; and
rendering the zoom-out summary of the contextual information of the current article on the GUI.

8. A machine-readable and non-transitory medium having information recorded thereon, wherein the information, when read by the machine, causes the machine to perform the following steps:
receiving a current article that a user is reviewing on a graphical user interface (GUI);
extracting, from the current article, relevant information;
retrieving contextual information associated with the current article based on the extracted relevant information;
automatically generating a zoom-out summary of the contextual information to characterize background of the current article; and
providing a zoom-out option to the user on the GUI that allows, once activated, the user to review the zoom-out summary of the contextual information providing the background associated with the current article.

9. The medium of claim 8, wherein the relevant information includes:
a source of the current article;
one or more entities mentioned in the current article; and
one or more topics that the current article covers.

10. The medium of claim 9, wherein the step of retrieving contextual information associated with the current article comprises:
identifying one or more historic documents/articles related to the one or more entities and/or the one or more topics via a knowledge representation characterizing relationships among a plurality of historic documents/articles;
retrieving, from a content archive, at least one of some of the one or more historic documents/articles and statistics associated with the one or more historic documents/articles; and
generating the contextual information based on what is retrieved from the content archive.

11. The medium of claim 10, wherein the one or more historic documents/articles and the statistics associated therewith are retrieved with respect to a first set of zoom-out summary parameter.

12. The medium of claim 8, wherein the step of automatically generating a zoom-out summary comprises:
receiving a second set of zoom-out summary parameters for controlling the generation of the zoom-out summary;
receiving the contextual information identified based on the relevant information extracted from the current article; and
creating, based on large language models (LLMs), the zoom-out summary of the contextual information in compliant with the second set of zoom-out summary parameters.

13. The medium of claim 12, wherein the second set of zoom-out summary parameters include at least one of:
a first parameter relating to topics to be covered by the zoom-out summary;
a second parameter relating to a limit to length of the zoom-out summary; and
a third parameter relating to a tone of text in the zoom-out summary.

14. The medium of claim 8, wherein the information, when read by the machine, further causes the machine to perform the following steps:
receiving an indication from the GUI that the user activates the zoom-out option; and
rendering the zoom-out summary of the contextual information of the current article on the GUI.

15. A system, comprising:
a story information extractor implemented by a processor and configured for:
receiving a current article that a user is reviewing on a graphical user interface (GUI), and
extracting, from the current article, relevant information;
a relevant past content retriever implemented by a processor and configured for retrieving contextual information associated with the current article based on the extracted relevant information;
a zoom-out summary generator implemented by a processor and configured for automatically generating a zoom-out summary of the contextual information to characterize background of the current article; and
a zoom-out information renderer implemented by a processor and configured for providing a zoom-out option to the user on the GUI that allows, once activated, the user to review the zoom-out summary of the contextual information providing the background associated with the current article.

16. The system of claim 15, wherein the relevant information includes:
a source of the current article;
one or more entities mentioned in the current article; and
one or more topics that the current article covers.

17. The system of claim 16, wherein the step of retrieving contextual information associated with the current article comprises:
identifying one or more historic documents/articles related to the one or more entities and/or the one or more topics via a knowledge representation characterizing relationships among a plurality of historic documents/articles;
retrieving, from a content archive, at least one of some of the one or more historic documents/articles and statistics associated with the one or more historic documents/articles; and
generating the contextual information based on what is retrieved from the content archive, wherein
the one or more historic documents/articles and the statistics associated therewith are retrieved with respect to a first set of zoom-out summary parameter.

18. The system of claim 15, wherein the step of automatically generating a zoom-out summary comprises:
receiving a second set of zoom-out summary parameters for controlling the generation of the zoom-out summary;
receiving the contextual information identified based on the relevant information extracted from the current article; and
creating, based on large language models (LLMs), the zoom-out summary of the contextual information in compliant with the second set of zoom-out summary parameters.

19. The system of claim 18, wherein the second set of zoom-out summary parameters include at least one of:
a first parameter relating to topics to be covered by the zoom-out summary;
a second parameter relating to a limit to length of the zoom-out summary; and
a third parameter relating to a tone of text in the zoom-out summary.

20. The system of claim 15, wherein the zoom-out information renderer is further configured for:
receiving an indication from the GUI that the user activates the zoom-out option; and
rendering the zoom-out summary of the contextual information of the current article on the GUI.
